(19) United States
(12) Patent Application Publication
(10) Pub. No.: US 2004/0235337 A1
(43) Pub. Date: Nov. 25, 2004

(54) Pull tab for electrical connector

(76) Inventors: Lung-Sheng Tai, Tu-Chen (TW); Chia-Ming Kuo, Tu-Chen (TW); Zhen-Da Hung, Tu-Chen (TW); Hsien-Chu Lin, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/853,621

(22) Filed: May 24, 2004

(30) Foreign Application Priority Data
May 23, 2003 (TW) 92209564

(51) Int. Cl. H01R 11/22

(52) U.S. Cl. 439/482

(57) ABSTRACT

A pull tab (1) for electrical connector includes a body (2), a first outspread arm (3) and a second outspread arm (4). The body includes a through hole (21) and a receiving space (24). A bottom wall (27), two side walls (22, 23) and two upper walls (25, 26) of the body define the receiving space. Each outspread arm bends from a corresponding upper wall perpendicular to the bottom wall. The pull tab is assembled to an electrical connector with the through hole mating with a mating portion of the electrical connector. The electrical connector is pulled out from a complementary device by the first and second outspread arms.

### CROSS-REFERENCE TO RELATED APPLICATIONS

Subject matter of this application is relevant to a co-pending patent application entitled “EXTRACTION TAB FOR EXTRACTING ELECTRICAL CONNECTOR”, invented by Lung-Sheng Tai et al, and assigned to the same assignee of the present application.

### BACKGROUND OF THE INVENTION

1. Field of the Invention

This invention relates to a pull tab for extracting an electrical connector from a complementary connector.

2. Description of the Prior Art

A pull tab is used for pulling an electrical connector out from a mounting device. One such pull tab is disclosed in JP Patent Publication No. 2001-035592, which provides a pulling arm, a through hole and an action portion. The through hole is defined in a center portion of the action portion. The pulling arm extends from the action portion. The through hole receives the electrical connector. When outside force is added to the pulling arm, the action portion will bring the force to the electrical connector in order to pull the electrical connector out from the mounting device.

However, the pulling arm of the pull tab is disposed on one side of the action portion. The direction of the force acting on the electrical connector inclines upwardly. The peripheral force acting on the electrical connector near the action portion is larger than the peripheral force acting on the electrical connector far from the action portion. In order to pull the electrical connector out from the mounting device, part of the electrical connector near the action is easily damaged by unbalanced force.

Hence, an improved pull tab is desired to overcome the above-mentioned shortcomings of the existing pull tab.

### BRIEF SUMMARY OF THE INVENTION

A primary object of the present invention is a pull tab for extracting an electrical connector from a complementary connector without damaging the electrical connector.

A pull tab in accordance with the present invention comprises a body, a first outspread arm and a second outspread arm. The body includes a through hole and a receiving space. Bottom wall, two side walls and two upper walls of the body define the receiving space. Each outspread arm bends from a corresponding upper wall perpendicular to the bottom wall. The pull tab is assembled to an electrical connector with the through hole mating with a mating portion of the electrical connector. The electrical connector is pulled out from a complementary device by pulling the first and second outspread arms.

Other objects, advantages and novel features of the invention will become more apparent from the following detailed description of preferred embodiments when taken in conjunction with the accompanying drawings.

### BRIEF DESCRIPTION OF THE DRAWINGS

FIG. 1 is a plan view of a pull tab unwrapped according to the present invention;

FIG. 2 is a perspective view of the pull tab of FIG. 1, which is wrapped for being assembled with an electrical connector; and

FIG. 3 is an assembled view of the pull tab of FIG. 2 and the connector.

### DETAILED DESCRIPTION OF THE INVENTION

One embodiment of the present invention will now be described with reference to the accompanying drawing.

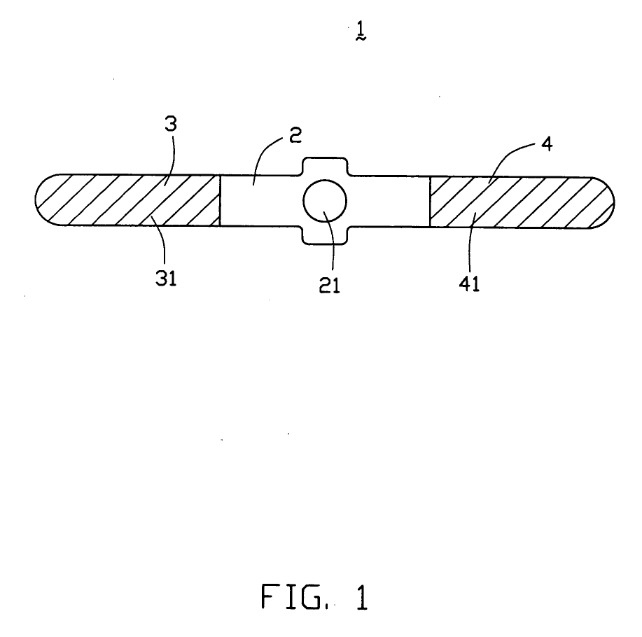

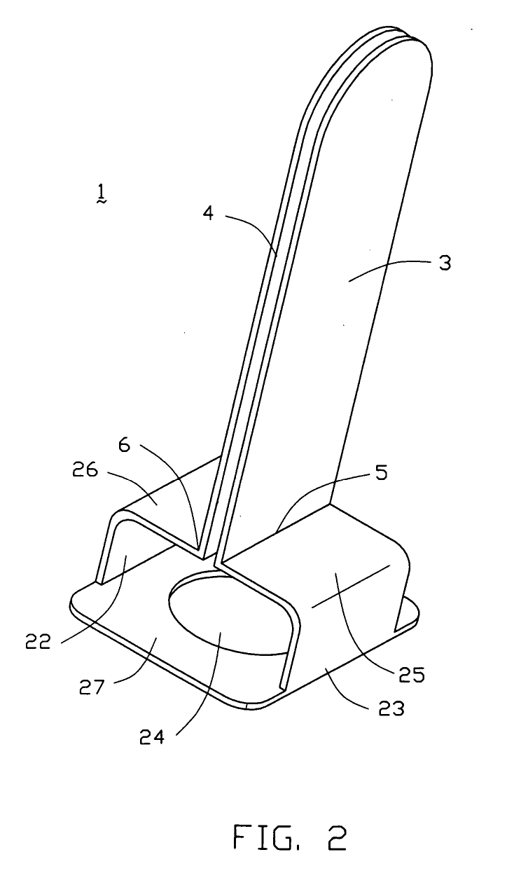

A pull tab 1 for electrical connector of the present invention is shown in FIGS. 1 and 2, having a body 2, a first outspread arm 3 and a second outspread arm 4. The body 2 includes a through hole 21 and a receiving space 24. Bottom wall 27, a first side wall 22, a second side wall 23, a first upper wall 25 and a second upper wall 26 of the body 2 define the receiving space 24. The through hole 21 is defined in a center portion of the bottom wall 27. Each outspread arm 3, 4 bends from a corresponding upper wall 25, 26. Each outspread arm 3, 4 is perpendicular to the bottom wall 27. The pull tab 1 includes a first adhensive portion 31 located on a free end of the first outspread arm 3 and a second adhensive portion 41 located on a free end of the second outspread arm 4. The first adhensive portion 31 is connected with the second adhensive portion 41.

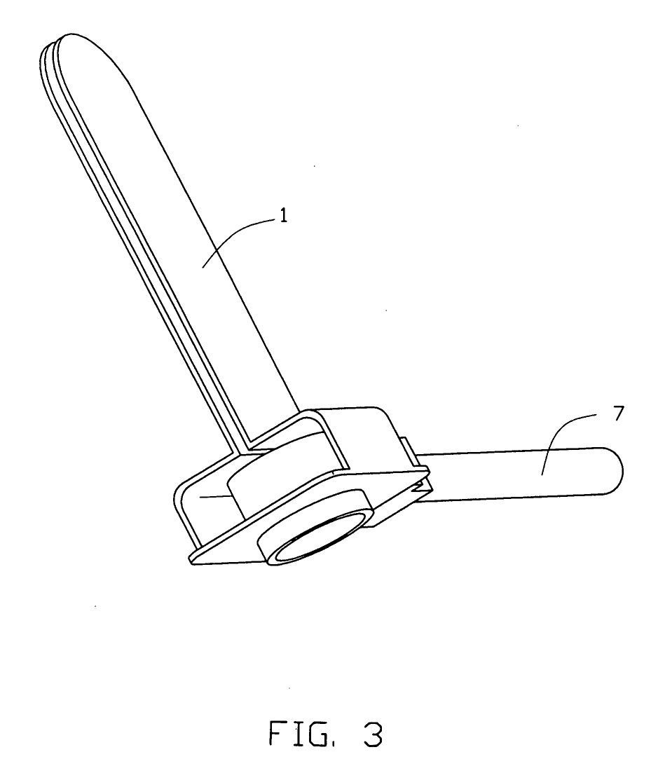

In FIG. 2 and FIG. 3, the pull tab 1 is wrapped to be assembled with an electrical connector 7. One end of the electrical connector 7 is received in the receiving space 24. A mating portion of the electrical connector 7 mating with a complementary device (not shown) extends through the through hole 21. The other end of the electrical connector 7 extends out of the receiving space 24.

It is to be understood, however, that even though numerous, characteristics and advantages of the present invention have been set forth in the foregoing description, together with details of the structure and function of the invention, the disclosed is illustrative only, and changes may be made in detail, especially in matters of shape, size, and arrangement of parts within the principles of the invention to the full extent indicated by the broad general meaning of the terms in which the appended claims are expressed.

What is claimed is:

1. A pull tab comprising:
a body comprising a bottom wall and a through hole defined in said bottom wall; and
a pulling portion extending from said body;
wherein said pulling portion is perpendicular to said bottom wall of said body.

2. The pull tab according to claim 1, wherein said body comprises a receiving space defined by two side walls and two upper walls thereof, said upper walls being separated from each other.

3. The pull tab according to claim 2, wherein said pulling portion comprises a first outspread arm and a second outspread arm, adhensively connected with each other.

4. A cable connector assembly comprising:
an electrical connector defining a downward mating port and a cable laterally extending perpendicular to said mating port;
a pull tab comprising:
a body comprising a bottom wall and a through hole defined in said bottom wall; and
a pulling portion including a pair of arms extending upwardly from two opposite
side edges of said body in a direction away from said mating port; wherein
said two side edges are parallel to said cable.

5. The assembly as claimed in claim 4, wherein said bottom wall further includes thereof a pair of extensions extending in a direction along said two side edges so as to efficiently support a housing of said connector.

6. The assembly as claimed in claim 5, wherein said pull tab is of a cross-like configuration when extended.
